(19) United States
(12) Patent Application Publication
(10) Pub. No.: US 2011/0038578 A1
(43) Pub. Date: Feb. 17, 2011

(54) CAGE FOR A ROLLING BEARING

(75) Inventors: Christian Brommer, Schweinfurt (DE); Rudolf Brueckner, Aurachtal (DE); Gordana Michos, Uechtelhausen (DE); Walter Rupprecht, Dachsbach (DE); Harry Schmeiko, Weisendorf (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/937,846

(22) PCT Filed: Apr. 3, 2009
(86) PCT No.: PCT/DE09/00457

§ 371 Date: Oct. 19, 2010

(30) Foreign Application Priority Data
Apr. 15, 2008 (DE) 10 2008 018 775.5
Jul. 2, 2008 (DE) 10 2008 030 917.6
Jul. 10, 2008 (DE) 10 2008 032 662.3

(51) Int. Cl. F16C 33/46

(52) U.S. Cl. 384/572

(57) ABSTRACT

A cage for rolling bodies of a rolling bearing, which has a first side ring, a second side ring axially spaced from the first side ring, and at least two webs, which connect the first side ring to the second side ring and among each other form a pocket for one of the rolling bodies. At least one of the webs has a first web part disposed at the first side ring and a second web part disposed at the second side ring, and a center web part offset with respect to the first and second web parts. The cage is configured such that it can withstand mechanical stresses via a support element which is provided and which supports the first web part and the second web part and connects the two side rings.

### FIELD OF THE INVENTION

The invention relates to a cage according to the preamble of claim 1 for rolling bodies of a rolling bearing.

Cages of said type are known from practice and from EP 1 262 256 B1 and are characterized in that the rolling bodies, usually cylindrical rollers, are inserted, under spring deflection, between the middle web part and the two web parts adjoining the side rings, such that the cage can be produced as a self-retaining cage equipped with rolling bodies. Here, the rolling bodies bear outside the pitch circle against guide surfaces on the two web parts adjoining the side rings, and inside the pitch circle against the middle web part. Here, the body of the cage is conventionally produced from sheet metal, with the radially turned middle web part being produced by means of a forming process. For said forming process, it must be ensured that the width of the middle web part is no smaller than the thickness of the metal sheet being deformed, such that the middle web part has a generally square cross section in a tangential sectional plane, for example along the pitch circle. Although said cages are easy to produce, they give rise to difficulties at high load ratings and high rotational speeds, because the cylindrical rolling bodies are arranged on guide surfaces for the rolling bodies in the region of the web parts adjoining the side rings, and therefore outside the pitch circle. Here, during operation, in particular during acceleration of the cage, tangential forces also occur which are introduced into the cage at the web parts. Here, forces occur which have the tendency to push the webs radially outward and the side rings away from one another, such that the rolling bodies can no longer be held in a defined manner, and the cage as a whole fails.

### OBJECT OF THE INVENTION

It is therefore the object of the invention to refine the cage mentioned in the introduction such that it can withstand higher mechanical loads.

### SUMMARY OF THE INVENTION

Said object is achieved according to the invention by means of a cage having the features of claim 1.

The first and second web parts which are reinforced by means of the support element and which are supported against one another can more effectively absorb the acting forces. It therefore remains possible for the cage to be produced with the middle web part from a thin metal sheet by means of the known forming process, with the thickness of the metal sheet continuing to be the limiting factor for the practicability of the forming process. In particular, no structural change to the cage itself is required, but rather it is sufficient for a cage, once it has been produced, to be provided retroactively with the support element.

Under the introduction of force, the two web parts, and therefore the web as a whole, no longer bend radially outward. The tendency, which still arises under the introduction of force, for the spacing of the side rings to vary is counteracted because the support element connects the two side rings.

It is also to be considered advantageous that the space formed between the middle web part and the support element can hold a grease reserve, such that the cage is sufficiently lubricated when put in operation for the first time.

It is preferably provided that the support element is aligned parallel to the middle web part at least in sections. It is thereby possible for at least one support element of the cage to be designed as a cylinder section matched to the curved outer contour of the cage. The support element may be arranged in the projection of the two web parts adjoining the side rings and may be fastened to the two web parts. The support element thereby ends flush with the outer contour of the rest of the cage. As an alternative to this, it may be provided that the support element is fastened to the two first and second web parts or to the outer lateral surface of the two side rings. In this case, the support element projects beyond the outer contour of the cage; here, the radially outwardly pointing side of the support element may have a coating which facilitates sliding of the cage.

It is preferably provided that a width of the support element in the region between the two web parts is greater than the width of the middle web part. Because the support element is not subjected, during its production, to the restrictions of the forming process of the rest of the cage, the width of the support element may be selected such that the rolling bodies which are held in the pockets no longer make contact with the support element and remain guided only on the first and second web parts, which are reinforced by the support element. A support element having a rectangular, no longer square cross section in a tangential sectional plane at the level of the pitch circle provides a particularly stable connection between the two side rings.

It is preferably provided that the support element is fixed to one of the side rings by means of a flanged portion. The flanged portion may be formed either by virtue of an edge portion of the support element being folded over onto the side ring or onto one of the web parts, or by virtue of an edge portion of one of the web parts or of the side ring being folded over onto the support element. Such a flanged portion is simple to provide and offers substantially linear fixing of the support element to the side ring or to the web part, which can absorb forces introduced by the rolling bodies in the region of the support element or in the region of the web part more effectively than a merely punctiform fastening of the support element to the side ring.

It is preferably provided that the support element is fixed to at least one of the two web parts by means of a weld, in particular by means of a spot weld. The weld, especially the spot weld, in the region of the web parts ensures that the junction between the web part and the support element is arranged substantially in the direction of action of the forces transmitted by the rolling bodies to the assembly composed of web part and support element. If the support element is fastened to the side ring outside the web parts by means of an in particular punctiform joining method, especially a spot weld, the forces transmitted by the rolling bodies to the cage generate a torque about the joining point, which torque can subject the fastening of the support element to the side ring to intense loading and can easily break said fastening under high load.

It is self-evident that a weld, in particular a spot weld, may also be provided in addition or as an alternative to the flanging joining method.

It is preferably provided that the support element is fixed to the side ring by means of an embossing. The embossing may be provided as an alternative or in addition to the weld, in particular the spot weld, and the flanged portion. Here, the embossing constitutes a connection which is planar at least in sections, and approximately positively locking, between the support element and the side ring, in particular also in the region of the web parts, which connection is simple to form, in particular as a calking so as to form two beads formed on the support element and on the side ring and directed toward one another, or as a clinch rivet.

Run-on surfaces are preferably provided in the region of the web parts. The run-on surfaces may be formed as simple beveled portions or may have a shaping substantially matched to the shape of the rolling bodies held in the pockets; for example, the run-on surfaces may have a contour complementary to the shape of the rolling bodies. The run-on surfaces reduce the friction between the rolling bodies and the cage, and permit a defined introduction of force between the rolling bodies and the cage in the region of the webs.

Run-on surfaces are preferably provided in the region of the support element. Here, only an indirect introduction of force takes place from the rolling bodies to the cage, via the support element. Here, the cage assumes the function of holding and retaining the rolling bodies, while the support element absorbs the forces introduced by the rolling bodies during operation.

It is self-evident that the run-on surfaces may be provided both on the webs and also on the support element. The run-on surfaces may be coordinated with one another such that the run-on surfaces of the web part and support element form a common, large run-on surface, or such that only one of the two run-on surfaces takes over the introduction of force during operation and the other run-on surface acts only in the event of failure of the first run-on surface, such that an emergency operation function can be obtained.

It is preferably provided that the cage comprises at least two support elements, and that in each case two adjacent support elements are combined to form a frame which surrounds a pocket. The support elements are constituent parts of the frame, which additionally comprises connecting elements between the support elements. The connecting elements may then be arranged on the outer lateral surface of the two support rings. Such frames can be produced easily by punching a window in a sheet-metal blank. The frame is then fastened to the cage such that the window of the frame is situated over the pocket of the cage. It may be provided in particular that every second pocket of the cage is surrounded by a frame, in order to enable mechanical support of the cage as a whole.

As an alternative to the combination of two or more support elements to form one or more frames, it is preferably provided that each of the webs of the cage comprises a support element, and that the support elements are combined to form a support cage which surrounds the cage and whose respective window is assigned to one of the pockets of the cage. The support cage may result from the individual support elements such that in each case two adjacent support elements are connected by means of at least one connecting element arranged on the outer lateral surface of the side ring, such that a cage-like device is formed which runs around the cage. Formed between in each case two support elements of the support cage is a window, between which the rolling bodies are arranged without coming into contact with the support elements. Here, each window of the support cage corresponds to a pocket of the cage. Such a support cage can be produced quickly and easily from a sheet-metal blank by punching out the windows and subsequently bending the sheet-metal blank. In particular, in the production of the support cage, a forming step in which the material thickness is changed is omitted, such that support cages of any desired thickness can be produced.

If the support elements are formed into a frame or a support cage, the frame or the support cage may be fixed to the cage by means of an edge-side flanged portion, or by means of a weld, especially a spot weld in the region of the web parts of the frame or of the support cage, or by means of an embossing. If the frame or the support cage is to be fixed to the cage by means of the flanged portion, the flanged portion may be formed only in sections, for example such that lugs or tongues are cut free at the outer edge of the frame or of the support cage, which lugs or tongues are folded over.

If the support elements are combined to form a frame or in particular to form a support cage, run-on surfaces may be provided on the frame or on the support cage, at which run-on surfaces the contact with the rolling bodies situated in the pockets takes place. Here, the frame or the support cage absorbs the forces introduced by the rolling bodies, while the cage serves to hold or mount only the rolling bodies themselves. In this way, only low forces are introduced into the cage itself, such that the cage can be of lightweight design and the cage can be of self-retaining design for the rolling bodies. In particular, the cage may be equipped with rolling bodies without the need for an auxiliary means for holding the rolling bodies in the cage. In particular, holding points may be provided in the region of the middle sections, which holding points prevent the rolling bodies inserted into the pockets from falling out of the pockets before the cage is inserted into the bearing.

With regard to the design of the support cage, it is preferably provided that an axial spacing between the opposite edges of the window of the support cage is smaller than an axial spacing between the first and second side rings in the region of the pockets. This permits the axial guidance of the rolling bodies on the support cage, which in the axial direction has an undersize in relation to the associated pocket of the cage, such that the cage itself is relieved of load. Furthermore, it has proven to be advantageous from a production aspect that, in the production of the window of the support cage, the dimensions of said window can be easily adjusted in the case of a punching process, while the axial dimension of the pockets of the cage can only be preset with a high level of expenditure, because the pockets of the cage are produced by means of a forming process involving material flow.

It is preferably provided that the support element, in particular the frame or the support cage, is formed from a fiber-reinforced plastic. Because the support element does not come into contact with the rolling bodies, it is sufficient for the support element to be produced from a mechanically stable but non-wear-resistant material which has a low specific weight. It is self-evident that not only the support element itself but rather also the frame or support cage as a whole may be produced from the fiber-reinforced plastic. As an alternative to this, the support element or the frame or support cage may be produced from a metal, in particular a light metal.

In the design of the support cage, it is preferably provided that a material thickness of the side rings and a material thickness of the support cage are coordinated with one another such that the support cage permits external or internal rim guidance of the cage.

As an alternative to this, it is preferably provided that an aid which facilitates sliding of the support cage is provided in sections on the outer lateral surface of the support cage. Such an aid may comprise a coating provided, or sliding pad or sliding shoes attached, at least in sections on the outer lateral surface of the support cage, wherein the coating may be composed for example of metallic materials such as steel or brass or of sintered materials or of plastics. It is likewise possible to provide metallically coated plastics as an aid for the sliding of the support cage.

The cage and the support cage surrounding it are preferably formed as bent sheet-metal parts or as a punched sheet-metal blank, either from a carbonitrided sheet-metal material or from sheet metal provided with a carbonitrided surface.

The support element may be attached to the cage by means of spot welding, linear welding or other welding processes, by means of soldering, adhesive bonding, shrink-fitting, clinching, flanging, riveting or other joining processes. In particular, with regard to the positively locking, cohesive or non-positively locking joining of the support element to the cage, there is an advantageous degree of freedom to be utilized from a production aspect.

This is correspondingly true if the support elements are held in the frame or in the support cage; here, the frame or the support cage may also be fastened to the cage outside the support elements, for example in the region of the connecting elements which connect the support elements. If a support cage is provided, a fastening of the support cage to the cage may be omitted, because the cage is pressed against the support cage under mechanical loading, and here, an at least non-positively locking connection is obtained between the cage and the support cage. Positionally accurate assignment of the support elements of the support cage to the webs of the cage is ensured during assembly as a result of the requirement for each rolling body in one of the pockets of the cage to also extend in sections through the window, which is assigned to the pocket of the cage, of the support cage.

Further advantages and features of the invention will emerge from the description of two exemplary embodiments and from the dependent claims.

The invention is described and explained in more detail below with reference to the appended drawings.

### BRIEF DESCRIPTION OF THE DRAWINGS

FIG. 1 shows, in a detail, a sectional view of a first exemplary embodiment of a cage according to the invention,

FIG. 2 shows, in a detail, a sectional view of a second exemplary embodiment of a cage according to the invention,

FIG. 3 shows, in a detail, a further sectional view of the second exemplary embodiment from FIG. 2,

FIG. 4 shows, in a detail, a sectional view of a third exemplary embodiment of a cage according to the invention,

FIG. 5 shows, in a detail, a sectional view of a fourth exemplary embodiment of a cage according to the invention,

FIG. 6 shows, in a detail, a plan view of a fifth exemplary embodiment of a cage according to the invention, and

FIG. 7 shows a partially sectional view of a sixth exemplary embodiment of a cage according to the invention.

### DETAILED DESCRIPTION OF THE DRAWING

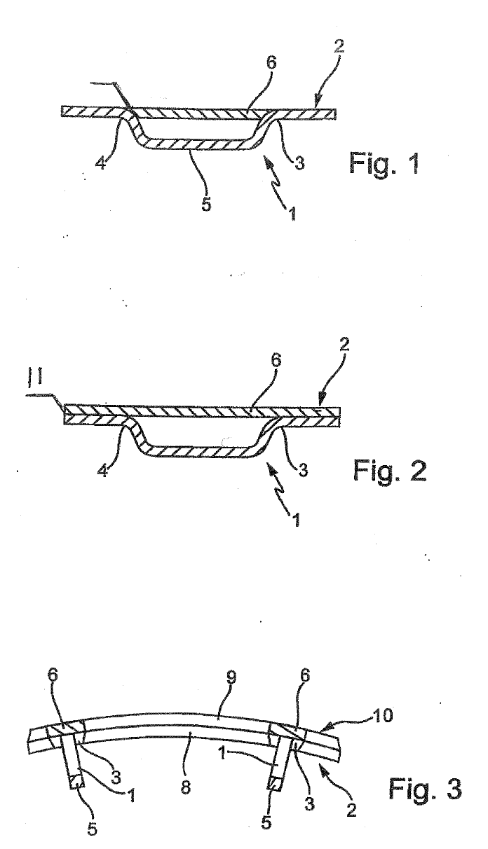

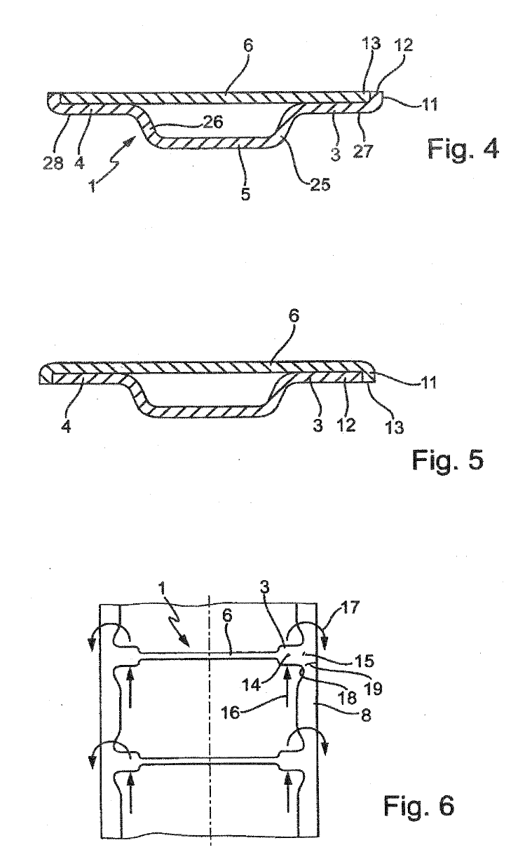

FIG. 1 shows a radial section along a web 1 of a cage 2, with the web 1 comprising a first web part 3, a second web part 4 and a middle web part 5 which is connected to the two web parts 3, 4 and which is radially offset with respect to the two web parts 3, 4. The two web parts 3, 4 and the middle web part 5 are produced in one piece with side rings (not illustrated) of the cage 2 and the rest of the body of the cage 2 in a forming process, wherein for the forming process it should be ensured that the extent of the middle web part 5 in a direction perpendicular to the drawing plane is not smaller than the width of the body of the cage 2, for example in the region of the web parts 3, 4. The web parts 3, 4 have in each case one portion 25, 26 (FIG. 4) turned in the direction of the middle web part 5. The middle web part 5 is fastened to the web parts 3, 4 at the turned portions 25, 26, and in particular merges into the web parts 3, 4.

A support element 6 is provided which stiffens the first web part 3 and the second web part 4 and connects the two side rings. The supporting action of the support element 6 for the two web parts 3, 4 consists in that the support element 6 prevents the two web parts 3, 4 from bending under the action of a force acting from below in the drawing plane. The support element 6 is arranged as an imaginary projection of the two web parts 3, 4 and is fastened to the two web parts 3, 4 by means of a spot weld.

Provided between the support element 6 and the middle web part 5 is a grease reserve (not illustrated). The support element 6 is aligned parallel to the middle web part 5.

FIG. 2 shows a web 1 of a cage 2, with the web 1 comprising a first web part 3, a second web part 4 and a middle web part 5 which is arranged between the two web parts 3, 4, is connected to these and is radially offset with respect to the two web parts 3, 4.

The web 1 is assigned a support part 6 which is arranged on the outwardly pointing lateral surface of the body of the cage 2 and which is fastened to the two web parts 3, 4 by means of spot welding. The support part 6 is arranged parallel to the middle web part 5, but no longer in alignment with the two web parts 3, 4.

FIG. 3 shows the detail of the cage from FIG. 2 in a sectional view, the section plane of which lies in the pitch circle plane, that is to say substantially between the two side rings. The section plane intersects two webs 1 in each case in the region of the middle web parts 5 and the stiffening elements 6. In the region of the two first web parts 3 of the two webs 1, it is possible to see beveled run-on surfaces 7, against which bear rolling bodies which are held between the webs 1. The rolling bodies do not make contact with the respective support element 6. The webs 1 and the run-on surfaces 7 are formed in one piece with the first side ring 8. The two support elements 6 are connected via connecting elements 9 to form a support cage 10 which extends along the circumference of the cage 2 beyond the two webs 1 illustrated in the drawing and which surrounds said cage 2 in the manner of a sleeve.

The support cage 10 is connected to the cage 2 by means of spot welds. The support cage 10 is designed and dimensioned in relation to the cage 2 in such a way as to enable external rim guidance of the cage 2 during operation.

FIG. 4 shows a web 1 of a cage (not illustrated in any more detail) having a support element 6 which is part of a support cage which supports the cage. The support element 6 is fixed to the side ring with the web parts 3, 4 by means of a flanged portion 11. The flanged portion 11 is formed such that an outer edge 12 of the first web part 3 is folded by approximately 90° axially toward the support element 6 such that the outer edge 12 engages over an outer edge 13 of the support part 6 of the support cage. Here, the end portion of the outer edge 12 of the first web part 3 ends substantially flush with the plane defined by the support element 6.

A flanged portion is provided correspondingly for fixing the support element 6 in the region of the second web part 4.

FIG. 5 shows a web 1 of a cage (not illustrated in any more detail) having a support element 6 which is part of a support cage which supports the cage. The support element 6 is likewise fixed by means of a flanged portion 11 to the side ring with the web parts 3, 4. The flanged portion 11 is designed such that an outer edge 13 of the support element 6 is folded over axially toward the first web part 3, such that the outer edge 13 engages over an outer edge 12 of the first web part 3.

A further flanged portion is provided correspondingly for fixing the web part 6 of the support cage in the region of the second web part 4.

The flanged portion 11 provided in each case in the above-described third and fourth exemplary embodiments was designed such that the outer edges 12, 13 of the first web part 3 and of the support element 6 were folded in each case by approximately 90° once. It is self-evident that the respective outer edge 12, 13 may also be folded by approximately 90° twice so as to surround the other outer edge in each case.

In the case of the flanged portions 11 provided in the third and fourth exemplary embodiments described above, it was provided in each case that the folded-over outer edge 12, 13 engages over the encompassed outer edge 13, 12 along the entire axial extent. It is self-evident that it is sufficient for the folded-over outer edge 12, 13 to engage over the encompassed outer edge 13, 12 in each case only along a part of the axial extent.

In the above-described third and fourth exemplary embodiments, the flanged portion 11 was formed in each case as a fold, running all the way around the support cage, of an outer edge 12, 13. It is self-evident that lugs or tongues may be cut into the support cage, which lugs or tongues are folded over such that the flanged portion 11 is provided along the circumference of the support cage only in sections.

FIG. 6 shows, as a fifth exemplary embodiment, a plan view of a section of a support cage 10 which is formed as a punched strip section. In the region of the first web part 3 of the web element, the support part 6 is fastened by means of a spot weld 14 to the first web part 3 and therefore to the side ring 8 of the cage. In relation to the forces (arrow 16) exerted by the rolling bodies during operation of the cage, the location of the spot weld 14 is selected such that the spot weld 14 lies in the projection of the forces introduced into the cage or into the support cage. A different selected location for the spot weld, for example the location 15 outside the web 1 in the region of the side ring 8 of the cage, leads to a torque (arrow 17) about the point 15 in the event of the introduction of force (arrow 16), which torque breaks the connection between the cage and the support cage. Furthermore, the torque (arrow 17) leads to the occurrence of stresses, which can cause cracks 19 in particular in the region of a notch 18 close to the transition from the web 1 to the side ring 8.

A junction, for example an embossing, especially a clinch rivet, may be formed in the region of the location 15, which junction has a substantially linear extent in the direction of the support element 6 and can more effectively absorb torques (arrow 17).

An embossing, especially a clinch rivet, is therefore provided at the joining point 15 in addition to or instead of the spot weld 14.

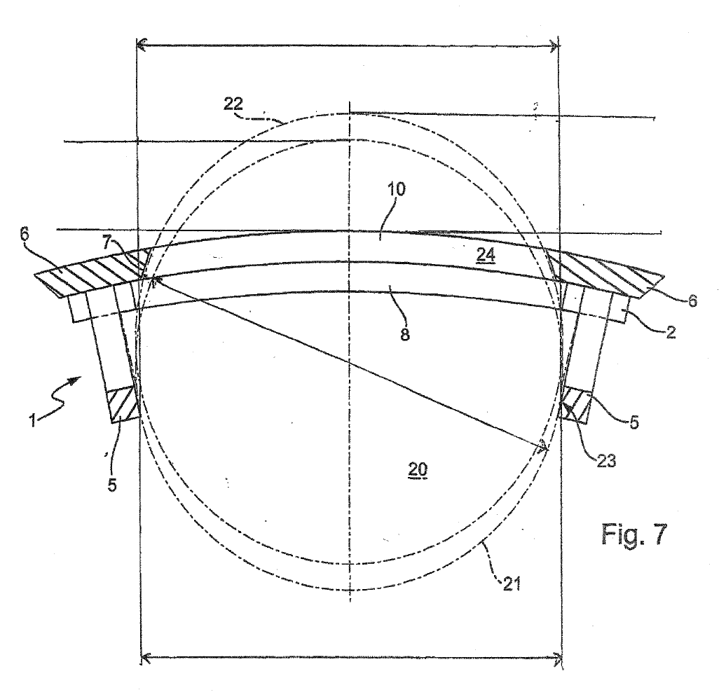

FIG. 7 shows a sixth exemplary embodiment of a cage having a side ring 8 and a support cage 10 which has support elements 6 in the region of the pockets. The section plane has been selected such that the middle web part 5 and also the support element 6 of the web 1 can be seen as cross-sectioned surfaces.

The illustration shows a rolling body 20, specifically in an insertion position (position 21) in which the rolling body 20 bears against retaining lugs 23 which are formed on the middle web part 5. The middle web part 5 thereby enables a self-retaining function for the cage 2 equipped with the rolling bodies 20, even if the cage 2 is provided outside the pitch circle. In particular, no additional auxiliary means are required in order to support the inserted rolling bodies 20 in the cage 2.

In the operating position (position 22) of the rolling body 20, the latter bears no longer against the retaining lugs 23 but rather against run-on surfaces which are provided on the support cage 10 in the region of the support element 6. The run-on surfaces 7 are formed as substantially beveled surface sections of that portion of the support element 6 of the support cage 10 which points toward the pocket. In contrast, in the second exemplary embodiment described above, the run-on surfaces 7 were arranged on the side ring 8 of the cage 2. In the operating position, no forces are introduced directly into the cage 2 by the rolling bodies 20; the introduction of force therefore takes place into the support cage 10 in the region of the run-on surfaces 7 of the support element 6.

The support cage 10 therefore relieves the cage 2 of load, which cage 2 is formed in particular in the region of the webs 1 with a sufficiently narrow web width to enable the middle web part 5 to easily receive the rolling bodies 20 which are inserted under spring deflection in the insertion position.

FIG. 7 also shows a connecting element 24 of the support cage 10, which connecting element fixedly connects two adjacent support elements 6, which form the pocket, of the support cage 10. The connecting element 24 is placed on the side ring 8 of the cage 2 and is fastened thereto.

In the exemplary embodiments described above, the space between the support element 6 and the middle web part 5 was left free and could contain a grease reserve. It is self-evident that the support element 6 may also have a protrusion in the direction of the middle web part 5. It is likewise possible for additional reinforcing elements to be provided between the middle web part 5 and the support element 6.

As an alternative to the second exemplary embodiment described above, a friction-reducing coating or friction-reducing elements may be provided on the outer lateral surface of the support cage 10 as a sliding aid; the friction-reducing elements may be arranged in the manner of clips and may be provided with an outwardly pointing friction-reducing coating.

In the above-described second and sixth exemplary embodiments, run-on surfaces 7 were provided in each case, which run-on surfaces 7 were provided on the cage 2 (second exemplary embodiment) or on the support cage 10 (sixth exemplary embodiment) and were formed in each case as beveled, substantially planar surfaces which make substantially linear contact with the cylindrical outer contour of the rolling body 20. It is self-evident that the run-on surfaces 7 may be provided on cages, the cage 2 and the support cage 10. It is also self-evident that the run-on surfaces may have a curved profile, for example a shaping may be provided which is substantially complementary to the shape of the rolling bodies 20, such that guide surfaces are formed and easier guidance of the rolling bodies 20 is made possible and the run-on surfaces 7 are formed with only a small area.

The invention has been described above on the basis of exemplary embodiments which had a U-shaped profile or M-shaped profile in the design of the web. It is self-evident that the invention can also be applied to other web configurations.

In the exemplary embodiments described above, the support element 6 of the web 1 was fastened in each case to those portions 27, 28 (FIG. 4) of the web parts 3, 4 which are substantially parallel to the middle web part 5. It is self-evident that the support element may alternatively or additionally also be fastened to the turned portions 25, 26 of the web parts 3, 4; it may be provided in particular that the support element 6 is fastened to the middle web part 5 and thereby supports and connects the two web parts 3, 4.

### List of Reference Numerals

1 Web

2 Cage

3 First web part

4 Second web part

5 Middle web part

6 Support element

7 Run-on surface

8 First side ring

9 Connecting element

10 Support cage

11 Flanged portion

12 Outer edge, first web part 3

13 Outer edge, support element 6

14 Spot weld

15 Joining point

16 Arrow (introduction of force)

17 Arrow (torque)

18 Notch

19 Crack

20 Rolling body

21 Rolling body in the insertion position

22 Rolling body in the operating position

23 Retaining lug

24 Connecting element

25 Turned portion of the first web part 3

26 Turned portion of the second web part 4

27 Parallel portion of the first web part 3

28 Parallel portion of the second web part 4

1. A cage for rolling bodies of a rolling bearing, comprising:
a first side ring;
a second side ring which is axially spaced apart from the first side ring; and
at least two webs which connect the first side ring to the second side ring and which between them form a pocket for one of the rolling bodies,
with at least one of the webs comprising a first web part, which is arranged on the first side ring, and a second web part, which is arranged on the second side ring, and a middle web part, which is offset in relation to the first web part and the second web part,
wherein a support element is provided which supports the first web part and the second web part and connects the two side rings.

2. The cage as claimed in claim 1, wherein the support element is aligned parallel to the middle web part at least in sections.

3. The cage as claimed in claim 1, wherein a width of the support element in a region between the first web part and the second web part is greater than a width of the middle web part.

4. The cage as claimed in claim 1, wherein the support element is fixed to one of the side rings by means of a flanged portion.

5. The cage as claimed in claim 1, wherein the support element is fixed to at least one of the two web parts by means of a weld.

6. The cage as claimed in claim 1, wherein the support element is fixed to the first side ring by means of an embossing.

7. The cage as claimed in claim 1, wherein run-on surfaces are provided in a region of the first web and the second web part.

8. The cage as claimed in claim 1, wherein run-on surfaces are provided in a region of the support element.

9. The cage as claimed in claim 1, wherein the cage comprises at least two support elements, and in that two adjacent support elements are combined to form a frame which surrounds a pocket of the cage.

10. The cage as claimed in claim 1, wherein each of the webs of the cage comprises a support element, and in that each support element is combined to form a support cage which surrounds the cage and whose respective window is assigned to one of the pockets of the cage.

11. The cage as claimed in claim 10, wherein an axial spacing between opposite edges of the window of the support cage is smaller than an axial spacing between the first support ring and the second support ring in a region of the pockets.

12. The cage as claimed in claim 1, wherein the support element, a frame or a support cage is formed from a fiber-reinforced plastic.

13. The cage as claimed in claim 10, wherein a material thickness of the side rings and a material thickness of the support cage are coordinated with one another such that the support cage permits external or internal rim guidance of the cage.

14. The cage as claimed in claim 10, wherein an aid which facilitates sliding of the support cage is provided in sections on an outer lateral surface of the support cage.

15. The cage as claimed in claim 1, wherein a grease reserve is provided between the middle web part and the support element.
